(19) United States
(12) Patent Application Publication
(10) Pub. No.: US 2015/0350040 A1
(43) Pub. Date: Dec. 3, 2015

(54) ENABLING AN EARLY RESPONSE TO A DISEASE BASED ON DATA ANALYTICS

(71) Applicant: HCL Technologies Ltd., Chennai (IN)

(72) Inventors: Mukta Agarwal, Noida (IN); Aravind Gorja, Noida (IN)

(21) Appl. No.: 14/720,962

(22) Filed: May 25, 2015

(30) Foreign Application Priority Data
Jun. 2, 2014 (IN) 2703/CHE/2014

(51) Int. Cl. H04L 12/26; H04L 29/08

(52) U.S. Cl. CPC H04L 43/04; H04L 67/18; H04L 67/22; H04L 67/24

(57) ABSTRACT

Enabling an early response to a disease based on data analytics. This invention relates to effective management of diseases and more particularly to effective management of disease by enabling an early and appropriate response to the disease using data analytics. The system comprises of a disease analytics platform connected to a plurality of data sources and at least one stakeholder.

### CROSS-REFERENCE TO RELATED APPLICATIONS

This application claims priority to Indian application no. 2703/CHE/2014 filed on Jun. 2, 2014, the complete disclosure of which, in its entirety, is herein incorporated by reference.

### FIELD OF INVENTION

This invention relates to effective management of diseases and more particularly to effective management of disease by enabling an early and appropriate response to the disease using data analytics.

### BACKGROUND OF INVENTION

Currently, disease management comprises of taking adequate steps (wherein the steps may be providing personal (doctors, nurses, other trained medical professionals and so on), equipment (beds, syringes, sterilization equipment and so on) and medicines, enforcing quarantines) in response to a disease outbreak. Initially, the reporting of the outbreak is normally done based on medical practitioners reporting cases of the disease to a monitoring authority. The authority based on the number of cases and severity of the disease, may decide on an appropriate response. The authorities may further inform stakeholders (such as personal, pharmaceutical companies and so on) of the outbreak, outlining the role that is to be played by each of the stakeholders.

The above mentioned steps are manual steps and require human intervention at each step. For example, the medical practitioners reporting to the authority and so on. This may cause problems, as the manual step may be too late or may be inadequate. For example, the authority may underestimate the size of the break and may send in fewer resources than required to the outbreak area. Also, the reporting may be inadequate as not all cases of the outbreak may not be reported, resulting in unreported small pockets of outbreak.

### OBJECT OF INVENTION

The principal object of this invention is to propose a method and system for providing an effective management of disease by enabling an early and appropriate response to the disease using data analytics.

### STATEMENT OF INVENTION

Accordingly the invention provides a method for enabling an early response to a potential outbreak of at least one disease by a disease analytics platform, the method comprising of stratifying data received from at least one user by the disease analytics platform to identify location of the at least one user; checking online patterns of a plurality of users in the identified location by the disease analytics platform; analysing call records of a plurality of users in that location by the disease analytics platform, on the disease analytics platform validating online patterns for mention of at least one disease, wherein the disease analytics platform may analyze call records for determining frequency of calls to medical practitioners; checking data from at least one of a social media platforms and an analytics platform for social media by the disease analytics platform for mention of at least one disease; determining if there is a potential outbreak of at least one disease by the disease analytics platform based on the online patterns, the call records and data from at least one of the social media platforms, the analytics platform for social media, historical data and historical trends; and sending an indication to at least one stakeholder by the disease analytics platform, on the disease analytics platform determining that there is a potential outbreak of at least one disease.

Also, provided herein is a system for enabling an early response to a potential outbreak of at least one disease, the system comprising of a disease analytics platform, the platform configured for stratifying data received from at least one user to identify location of the at least one user; checking online patterns of a plurality of users in the identified location; analysing call records of a plurality of users in that location, on the disease analytics platform validating online patterns for mention of at least one disease, wherein the disease analytics platform may analyze call records for determining frequency of calls to medical practitioners; checking data from at least one of a social media platforms and an analytics platform for social media for mention of at least one disease; determining if there is a potential outbreak of at least one disease based on the online patterns, the call records and data from at least one of the social media platforms, the analytics platform for social media, historical data and historical trends; and sending an indication to at least one stakeholder, on the disease analytics platform determining that there is a potential outbreak of at least one disease.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, through out which like reference letters indicate corresponding parts in the various figures. The embodiments herein will be better understood from the following description with reference to the drawings, in which:

FIG. 1 depicts a system comprising of a disease analytics platform connected to a plurality of data sources and at least one stakeholder, according to embodiments as disclosed herein;

FIG. 2 depicts a disease analytics platform, according to embodiments as disclosed herein; and

FIGS. 3a and 3b are flowcharts illustrating the process of a disease analytics platform analyzing data to check for presence of a disease outbreak, according to embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

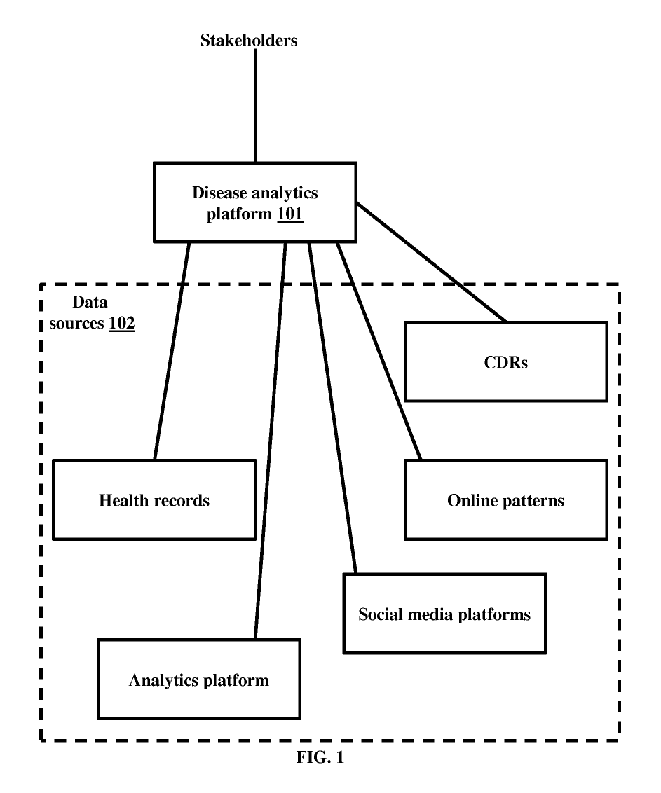

The embodiments herein propose a method and system for providing an effective management of disease by enabling an early and appropriate response to the disease using data analytics. Referring now to the drawings, and more particularly to FIGS. 1 through 3, where similar reference characters denote corresponding features consistently throughout the figures, there are shown preferred embodiments.

FIG. 1 depicts a system comprising of a disease analytics platform connected to a plurality of data sources and at least one stakeholder, according to embodiments as disclosed herein. The figure depicts a disease analytics platform 101 connected to a plurality of data sources 102 and a plurality of stakeholders. The data sources 102 may comprise of at least one of Call Data Records (CDRs) of users (which may include call history, SMS (Short Messaging Service) history and so on), online patterns of user (such as the search history, the browsing history, the IM (Instant Messaging) history and so on), social media networks (such as Facebook, Twitter, Instagram, Pinterest and so on), social media analytics platforms (PeekAnalytics, BlitzMetrics and so on), analytics platforms, public and private health record repositories (such as hospital call records, clinic call records, patient data and so on) and so on.

The CDRs may be obtained from the devices being used by the user, wherein the device may be at least one of a mobile phone, a tablet, a computer, wearable computing device and so on. The disease analytics platform 101 may obtain the devices using at least one of a wired connection means or a wireless connection means or any other connection means that the devices may use for communication. The online patterns of the user may be obtained from at least one application present on the device, wherein the application enables the user to maintain an online presence. The application may be at least one of a browser, a dedicated application (such as Google Now and so on) and so on. The disease analytics platform 101 may take the requisite permissions from the users before fetching data from the devices and/or applications, wherein the data may also comprise of the location of the user.

The stakeholders may comprise of a regulatory authority (such as CDC (Center for Diseases Control), the health ministries, national government officials, local officials and so on), at least on pharmaceutical company (such as companies that may produce medicines related to the disease), medical equipment manufacturers and suppliers and so on.

The disease analytics platform 101 may receive information from the plurality of data sources 102, wherein the data may be in the form of online searches for diseases in a particular area, browsing for information about a disease, discussions over voice call, text based messaging systems, frequency of call/visits made to a hospital/clinic with reference to the disease and so on about diseases within a specific area (which may be based on the location of the user). Based on this information, the disease analytics platform 101 determines if there is a requirement to take at least one action. The action may comprise of provisioning for procuring and distributing sufficient medicines/vaccines (based on the nature of the disease, number of possible occurrences of the disease, availability of medicines/vaccines and so on), provide location based alerts about the occurrence of the disease to a user, provisioning for adequate healthcare services (in terms of medical practitioners, equipment and so on) and so on. The disease analytics platform 101 may route the action to the respective stakeholder. For example, for procuring and distributing sufficient medicines/vaccines, the disease analytics platform 101 may send an indication to the authorities, pharmaceutical companies and distributors. The indication may comprise of the type of disease, the number of possible cases, the locations where the cases may occur and so on. The disease analytics platform 101 may also enable the stakeholders to access information related to the other stakeholders and interact with the stakeholders, who may have a role to play in controlling and managing the disease. The disease analytics platform 101 may enable the authorities to send customized alerts to the users.

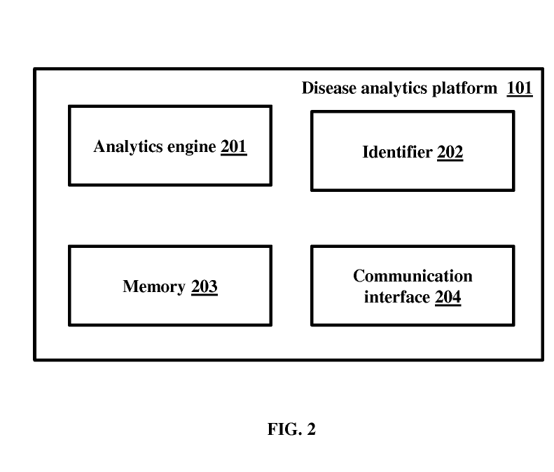

FIG. 2 depicts a disease analytics platform, according to embodiments as disclosed herein. The disease analytics platform 101 may comprise of an analytics engine 201, an identifier module 202, a memory 203 and a communication interface 204. The memory 203 may be used to store data received from the data sources 101. The memory 203 may also store information about the stakeholders. The stakeholder information may comprise of the pharmaceutical companies, the location of the pharmaceutical companies, the medicines/vaccines available with the pharmaceutical companies, the list of authorities, the list of hospitals, the locations of the hospitals, the capabilities and equipment available with each of the hospitals and so on. The memory 203 may store data related to diseases such as symptoms of the users with the disease, the level of virulence of the disease, the mode of propagation of the disease, the medicines that may be effective on each disease, the pharmaceutical companies that may manufacture the medicines, the dormancy period of the disease, the medical practitioners with the ability to treat the disease and so on. The memory 203 may also store historical data. The memory 203 may be a data storage location, co-located with the platform 101. The memory 203 may be a data storage location, located remotely from the platform 101 and connected to the platform 101 using a suitable connection means. The memory 203 may be a database, configured to enable storage of information.

The communication interface 204 may enable the platform 101 to send and/or receive information to and from the data sources. The communication interface 204 may also enable the platform 101 to send information to the stake holders. The communication interface 204 may use a plurality of interfaces to communicate with the data sources and stakeholders, such as an interface which uses a wired connection means or interface which uses a wireless connection means.

On receiving data through the communication interface 204, the analytics engine 201 stratifies the data, based on the location of the user. On identifying the location of the user, the analytics engine 201 checks the online patterns of users present in vicinity of the identified location for any disease related activities (searching, browsing, discussing and so on). If there are significant disease related online activities resulting from various users belonging to the same location, the analytics engine 201 may validate the prevalence of disease spread at a first level. The analytics engine 201 may also take into account the probability of false activities.

The analytics engine 201 may further analyze the call records to find out the frequency of calls from the given location to various medical practitioners. The analytics engine 201 may user contact numbers of medical practitioners on which majority of users may call, which may be present in the memory 203. This may indicate the probable disease spread/prevalence in a given location, while the online patterns will give an understanding of the type of disease. If the frequency of calls is above a pre-defined threshold, the analytics engine may consider that there is a possibility of the disease occurring in a specific location. The pre-defined threshold may be defined an authorized person and/or entity. The analytics engine 201 may mine the transcripts of the calls to determine the disease/problem that has been discussed with the medical practitioner (if the transcripts are available). The analytics engine 201 may mine the transcripts to identify the physician referred to in the call and the engine 201 uses the name of the physician to determine the potential disease (as the details of the physician such as his specialty and so on may be available to the engine 201).

The analytics engine 201 further compares the previous analysis to data coming from social media analytics platforms. The social media analytics platforms perform behavioral and sentiment analysis of the users on these social media platforms, wherein the analysis done by the platforms may be used to bring out a picture of ongoing trends. The analytics engine 201 may also use disease related data and the historic trends for analysis.

Based on the data, the analytics engine 201 may infer that there is a possibility of a disease outbreak in a location. The analytic engine 201 may also determine the identified disease, location where the outbreak is expected to occur, expected size of outbreak and so on The identifier 202 based on the identified disease, location, expected size of outbreak and so on, may identify at least one stakeholder. The identifier 202 may use information from the data sources, the memory 203 or any other source of data to identify the stakeholders. Based on the identified stakeholders, the analytics engine 201 may send an indication to the stakeholders, wherein the indication may comprise of the identified disease, location, expected size of outbreak and so on. The analytic engine 201 may also inform the stakeholders of the steps to be taken to prevent and/or minimize the size and effects of the outbreak in terms of the equipment, personal, medicines and so on required for controlling the expected size of the outbreak. The analytic engine 201 may use the communication interface 204 to send the indication to the stakeholders.

The analytic engine 201 may also send an indication to users in that location, warning them of the disease, the precautions to be taken and so on. The analytic engine 201 may use the communication interface 204 to send the indication to the users.

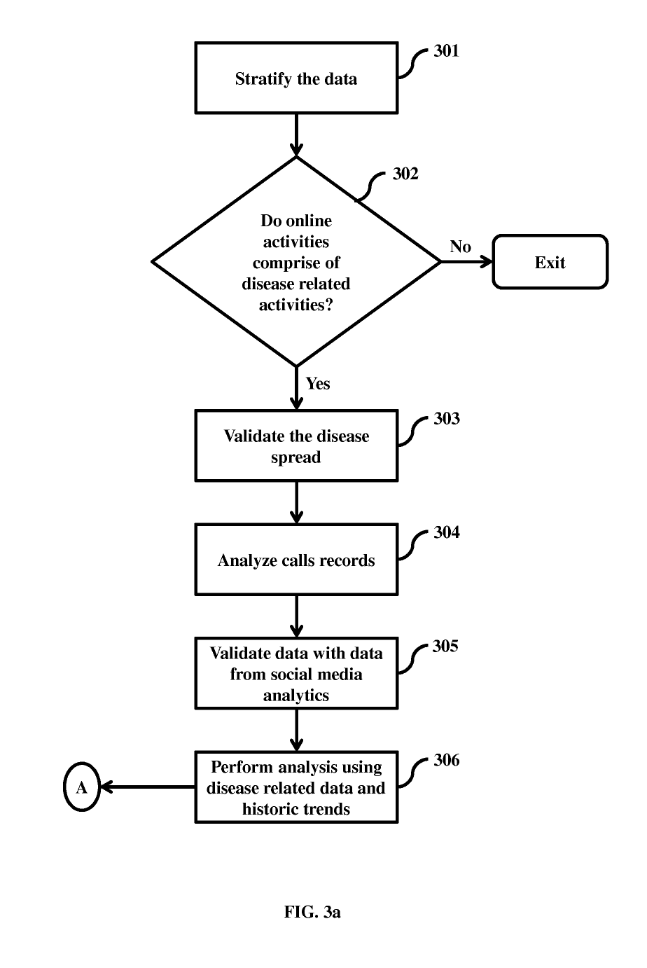

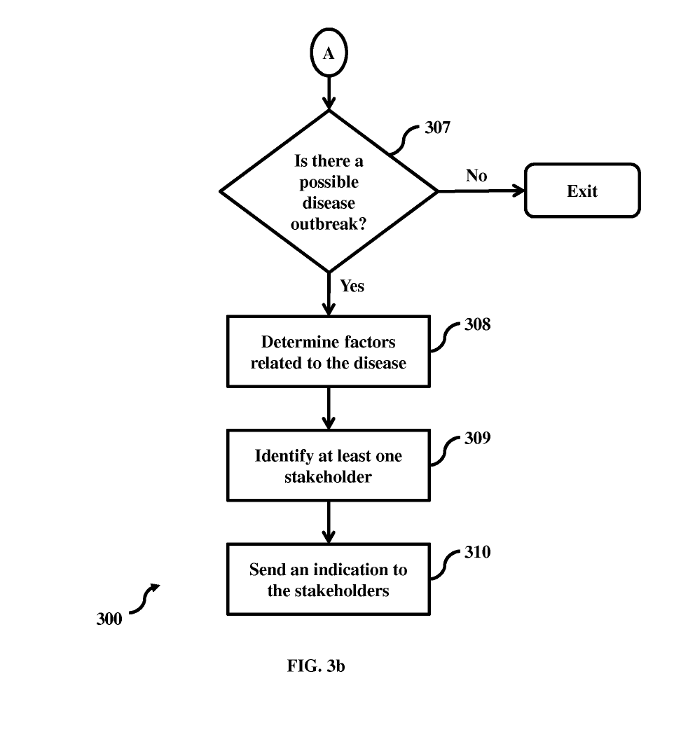

FIGS. 3a and 3b are flowcharts illustrating the process of a disease analytics platform analyzing data to check for presence of a disease outbreak, according to embodiments as disclosed herein. On receiving data from the data sources, the disease analytics platform 101 stratifies (301) the data, based on the location of the user. On identifying the location of the user, the disease analytics platform 101 checks (302) the online patterns of users present in vicinity of the identified location for significant disease related activities (searching, browsing, discussing and so on). If there are significant disease related online activities resulting from various users belonging to the same location, the disease analytics platform 101 validates (303) the prevalence of disease spread at a first level. The disease analytics platform 101 may also take into account the probability of false activities. The disease analytics platform 101 further analyzes (304) the call records to find out the frequency of calls from the given location to various medical practitioners. The disease analytics platform 101 further validates (305) the previous analysis based on data coming from social media analytics platforms. The disease analytics platform 101 performs (306) analysis using disease related data and historic trends. Based on the data, the disease analytics platform 101 checks (307) if there is a possibility of a disease outbreak in a location. If there is a possibility of a disease outbreak in a location, the disease analytics platform 101 also determines (308) factors related to the disease, such as the identified disease, location where the outbreak is expected to occur, expected size of outbreak and so on The disease analytics platform 101 based on the identified disease, location, expected size of outbreak and so on, identifies (309) at least one stakeholder. The disease analytics platform 101 may use information from the data sources, the memory or any other source of data to identify the stakeholders. Based on the identified stakeholders, the disease analytics platform 101 sends (310) an indication to the stakeholders, wherein the indication may comprise of the identified disease, location, expected size of outbreak and so on. The analytic engine 201 may also inform the stakeholders of the steps to be taken to prevent and/or minimize the size and effects of the outbreak in terms of the equipment, personal, medicines and so on required for controlling the expected size of the outbreak. The disease analytics platform 101 may also send an indication to users in that location, warning them of the disease, the precautions to be taken and so on. The various actions in method 300 may be performed in the order presented, in a different order or simultaneously. Further, in some embodiments, some actions listed in FIGS. 3a and 3b may be omitted.

The real time data about the potential outbreak of a disease provided by the embodiments disclosed herein enables a relatively more accurate demand forecast that would enable the pharmaceutical manufacturers to plan for the production and retailers to stock up the required medicines/vaccines to avoid shortage.

Once embodiments disclosed herein identify the possible disease outbreaks, medicine/vaccine distribution centers are alerted with the location based demand and required medicine/vaccine quantity estimates; this would equip the authorities to achieve optimized distribution of medicines/vaccines and in turn mitigate the wastage which results in huge cost savings for the healthcare sector.

Embodiments disclosed herein disclose a more efficient method for distribution of medicines/vaccines. The overall number of medicines/vaccines allocated for a disease (disease1) using embodiments disclosed herein where P is the probability of the disease spread in a given zone is calculated as,

Σₖ₌₀ⁿVk=Z1D1P1+Z2D1P2+Z3D1P3 . . . +ZkD1Pk=Σₖ₌₀ⁿZkD1Pk

where

V1 is the number of vaccines allocated for zone1

Z1 is the population in zone1; and

D1 is the type of medicine/vaccine for the identified disease

Considering the location based probability of the disease spread that is quantified by the real time data as an additional factor, embodiments disclosed herein estimation of the medicine/vaccine requirements for each zone with better accuracy, hereby reducing the medicine/vaccine wastage rates.

Embodiments disclosed herein enable identifying misconceptions related to diseases, hereby enabling creation of targeted awareness programs to eradicate the identified misconceptions about the disease.

The embodiments disclosed herein can be implemented through at least one software program running on at least one hardware device and performing network management functions to control the network elements. The network elements shown in FIGS. 1 and 2 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for enabling an early response to a potential outbreak of at least one disease by a disease analytics platform, the method comprising of
stratifying data received from at least one user by the disease analytics platform to identify location of the at least one user;
checking online patterns of a plurality of users in the identified location by the disease analytics platform;
analysing call records of a plurality of users in that location by the disease analytics platform, on the disease analytics platform validating online patterns for mention of at least one disease, wherein the disease analytics platform may analyze call records for determining frequency of calls to medical practitioners;
checking data from at least one of a social media platforms and an analytics platform for social media by the disease analytics platform for mention of at least one disease;
determining if there is a potential outbreak of at least one disease by the disease analytics platform based on the online patterns, the call records and data from at least one of the social media platforms, the analytics platform for social media, historical data and historical trends; and
sending an indication to at least one stakeholder by the disease analytics platform, on the disease analytics platform determining that there is a potential outbreak of at least one disease.

2. The method, as claimed in claim 1, wherein the method further comprises of the disease analytics platform validating that frequency of calls to medical practitioners is above a pre-defined threshold.

3. The method, as claimed in claim 1, wherein the method further comprises of the disease analytics platform determining at least one stakeholder, based on the location, potential size of the outbreak and the disease.

4. The method, as claimed in claim 1, wherein the method further comprises of the disease analytics platform indicating at least one action to be taken in response to the potential outbreak of the disease to the at least one stakeholder.

5. A system for enabling an early response to a potential outbreak of at least one disease, the system comprising of a disease analytics platform, the platform configured for
stratifying data received from at least one user to identify location of the at least one user;
checking online patterns of a plurality of users in the identified location;
analysing call records of a plurality of users in that location, on the disease analytics platform validating online patterns for mention of at least one disease, wherein the disease analytics platform may analyze call records for determining frequency of calls to medical practitioners;
checking data from at least one of a social media platforms and an analytics platform for social media for mention of at least one disease;
determining if there is a potential outbreak of at least one disease based on the online patterns, the call records and data from at least one of the social media platforms, the analytics platform for social media, historical data and historical trends; and
sending an indication to at least one stakeholder, on the disease analytics platform determining that there is a potential outbreak of at least one disease.

6. The system, as claimed in claim 5, wherein the platform is further configured for validating that frequency of calls to medical practitioners is above a pre-defined threshold.

7. The system, as claimed in claim 5, wherein the platform is further configured for determining at least one stakeholder, based on the location, potential size of the outbreak and the disease.

8. The system, as claimed in claim 5, wherein the platform is further configured for indicating at least one action to be taken in response to the potential outbreak of the disease to the at least one stakeholder.
